(19) United States
(12) Patent Application Publication
(10) Pub. No.: US 2026/0340120 A1
(43) Pub. Date: Oct. 29, 2026

(54) IMAGE FORMING APPARATUS

(71) Applicant: BROTHER KOGYO KABUSHIKI KAISHA, Nagoya (JP)

(72) Inventor: Yutaka URAKAWA, Nagoya (JP)

(73) Assignee: BROTHER KOGYO KABUSHIKI KAISHA, Nagoya (JP)

(21) Appl. No.: 19/569,351

(22) Filed: Mar. 17, 2026

(30) Foreign Application Priority Data
Apr. 24, 2025 (JP) 2025-072255

(51) Int. Cl. G06F 21/55; H04N 1/00; H04N 1/44

(52) U.S. Cl. CPC G06F 21/554; H04N 1/00204; H04N 1/00413; H04N 1/00477; H04N 1/4433; G06F 2221/034; H04N 2201/0094

(57) ABSTRACT

An image forming apparatus includes a plurality of communication interfaces, a user interface, and a controller. Each of the plurality of communication interfaces is configured to be set to enabled or disabled. The image forming apparatus is capable of communicating via a communication interface included in the plurality of communication interfaces and set to enabled. In response to the controller accepting, via the user interface, a designating and enabling operation for instructing the controller to designate a communication interface, which is included in the plurality of communication interfaces and which has been set to disabled, and to set the communication interface to enabled, the controller is configured to cause the user interface to display a message warning a security compromise.

### REFERENCE TO RELATED APPLICATIONS

This application claims priority from Japanese Patent Application No. 2025-072255 filed on Apr. 24, 2025. The entire content of the priority application is incorporated herein by reference.

### BACKGROUND ART

In a known technique, an EWS (Embedded Web Server) is used to accept an instruction to change a setting value of an image forming apparatus.

### SUMMARY

In the above known technique, scenarios where the instruction to change the setting value might compromise the security have not been anticipated.

An object of the present disclosure is to provide a technique regarding a warning to be issued in a case where an instruction to change the setting value might compromise the security.

An image forming apparatus according to an aspect of the present disclosure includes: a plurality of communication interfaces; a user interface; and a controller. Each of the plurality of communication interfaces is configured to be set to enabled or disabled. The image forming apparatus is capable of communicating via a communication interface included in the plurality of communication interfaces and set to enabled. In response to the controller accepting a designating and enabling operation via the user interface, the controller is configured to cause the user interface to display a message warning a security compromise. The designating and enabling operation is an operation for instructing the controller to designate a communication interface in the plurality of communication interfaces being set to disabled, and to set the communication interface to enabled.

According to the image forming apparatus described in an embodiment, the controller is capable of issuing a warning in a case where the instruction to change the setting value might compromise the security.

### BRIEF DESCRIPTION OF DRAWINGS

FIG. 1 is a block diagram of an image forming system.

FIG. 2 is a flowchart illustrating an example of the procedure in which a PC obtains Physical Interface setting screen data from an MFP.

FIGS. 3A and 3B depict a flowchart illustrating the procedure of a Physical Interface setting screen display and operation process.

FIG. 4 illustrates an example of a Physical Interface setting screen displayed on a browser.

FIGS. 5A to 5D illustrate an example of display when I/Fs, which are a part of a plurality of I/F included in the Physical Interface setting screen, are switched between "Enabled" and "Disabled".

FIGS. 6A and 6B depict a flowchart illustrating the procedure of a modification of the Physical Interface setting screen display and operation process.

FIGS. 7A to 7C illustrate a modification of the display when I/Fs, which are a part of a plurality of I/F included in the Physical Interface setting screen, are switched between "Enabled" and "Disabled".

FIGS. 8A to 8C illustrate an example of a screen transition displayed on a user I/F.

FIGS. 9A to 9D illustrate another example of the screen transition displayed on the user I/F.

### DESCRIPTION

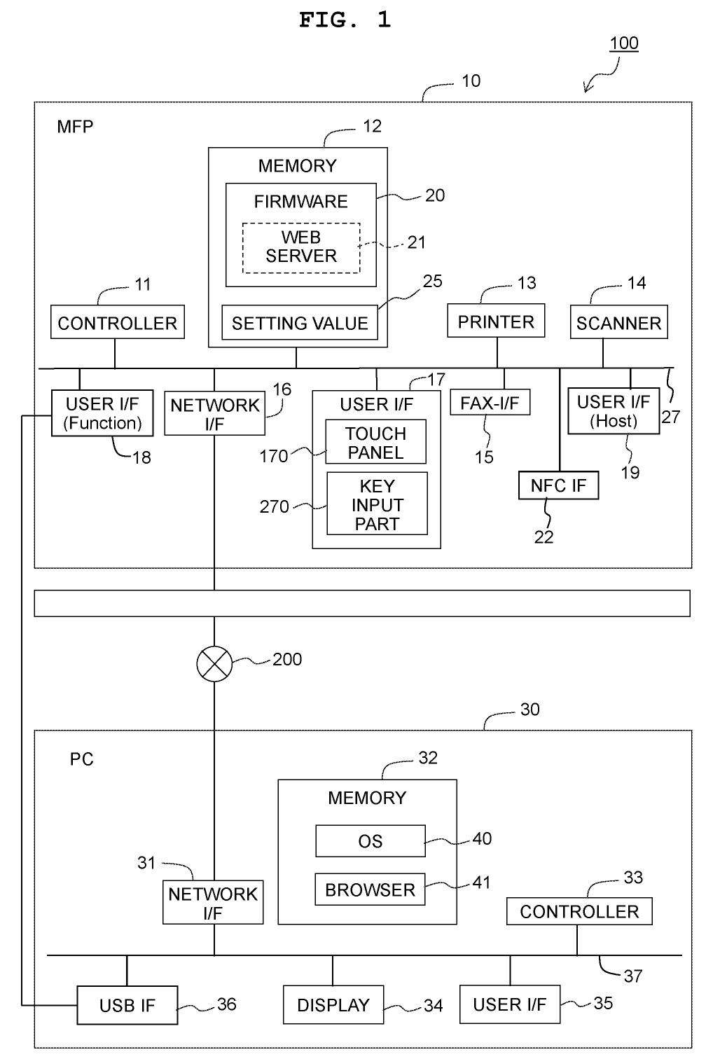

An image forming system 100 according to an embodiment of the present disclosure will be described below with reference to the drawings. The image forming system 100 illustrated in FIG. 1 includes an MFP (abbreviation of "multifunction peripheral") 10, and a PC 30. The MFP 10 and the PC 30 are connected to a network 200. The MFP 10 and the PC 30 are capable of communicating with each other via the network 200. The network 200 is a LAN or the Internet. In the present embodiment, the MFP 10 is an example of the image forming apparatus.

The MFP 10 includes a controller 11, a memory 12, a printer 13, and a scanner 14. The MFP 10 further includes a FAX-I/F 15, a network I/F 16, a user I/F 17, a USB I/F 18, a USB I/F 19, an NFC I/F 22, and a bus 27. The term "USB" (registered trademark) is an abbreviation of "Universal Serial Bus". The term "NFC" is an abbreviation of "Near Field Communication". In the present embodiment, the FAX-I/F 15, the network I/F 16, the USB I/F 18, the USB I/F 19, and the NFC I/F 22 are example of the plurality of communication interfaces.

The network I/F 16 connects the MFP 10 to a network 200 in conformity with a predetermined network protocol. The communication connecting the MFP 10 to the network 200 may be wired communication or wireless communication.

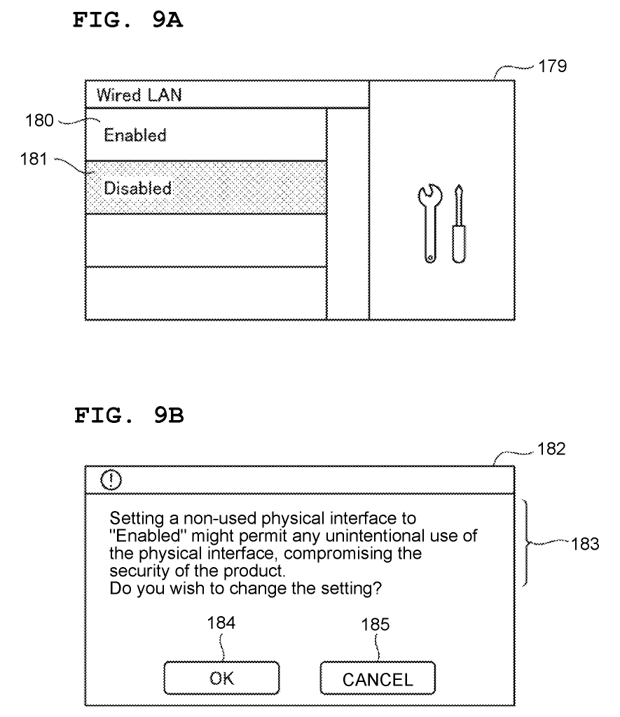

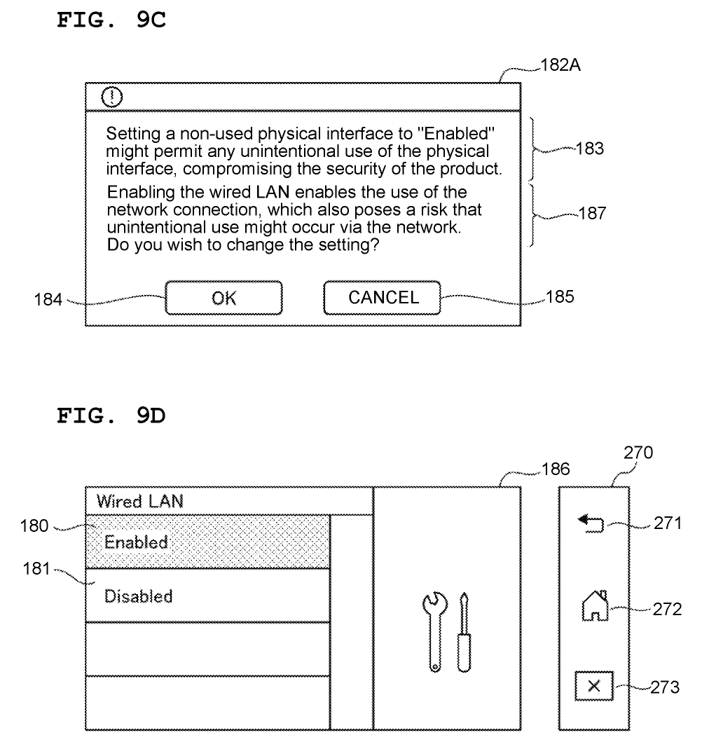

The user I/F 17 is an interface interposed between a user who directly operates the MFP 10 and the controller 11. The user I/F 17 includes a touch panel 170 and a key input part 270. The key input part 270 is constructed of a plurality of keys which are, for example, three keys. In the present embodiment, as illustrated in FIG. 9D, the three keys are a return key 271, a home key 272, and a cancel key 273. Each of the plurality of keys is switchable between a lit state and an unlit state, for example, in response to a backlight being turned on and off.

The printer 13 performs a printing operation for printing an image on a medium such as a sheet or a disk. For example, the electrophotography system, the ink-jet system, etc., may be adopted as the recording system of the printer 13. The scanner 14 performs a scanning operation for reading an image recorded on an original and generating image data. The FAX-I/F 15 performs a fax operation for transmitting/receiving image data in accordance with a system in conformity with the fax protocol. Further, the MFP 10 is also capable of performing a multifunctional operation for combining a plurality of operations. A copying operation for combining the printing operation performed by the printer 13 and the scanning operation performed by the scanner 14 is an example of the multifunction operation.

The USB I/F 18 is an interface provided for a USB (registered trademark) function. The USB (registered trademark) function causes the MFP 10 to operate as a USB device with respect to an external apparatus connected to the MFP 10. In the present embodiment, the PC 30, which operates as a USB host, is assumed as an example of the external apparatus. A Standard-B receptacle is used as a connector for the USB I/F 18. The USB I/F 19 is an interface for a USB (registered trademark) host function. The USB (registered trademark) host function is a function to use a USB device connected to the MFP 10. In the present embodiment, a USB memory device is assumed as an example of the USB device. A Standard-A receptacle is used as a connector for the USB I/F 19.

The NFC I/F 22 is an interface configured to perform short-range wireless communication based on a telecommunications standard included in the category of NFC.

The controller 11 is constructed, for example, of a CPU or an ASIC (abbreviation of "Application Specific Integrated Circuit"). The controller 11 controls the operation of each of the printer 13, the scanner 14, and the FAX-I/F 15. Further, the controller 11 also controls the operation of each of the network I/F 16, the user I/F 17, the user I/F 18, the user I/F 19, and the NFC I/F 22.

The memory 12 includes a data storage region. The data storage region stores, for example, data required to execute, for example, a program. The memory 12 is constructed, for example, of a RAM, a ROM, an SSD, and an HDD which are combined. A non-illustrated buffer, which is included in the controller 11 and which is used in a case where various programs are executed, is also a part of the memory 12. Note that the memory 12 may be a storage medium which is readable by the controller 11. The storage medium, which is readable by the controller 11, is a non-transitory medium. In addition to the above-described examples, the non-transitory medium also includes a recording medium such as a CD-ROM and a DVD-ROM. Further, the non-transitory medium is also a tangible medium. On the other hand, electric signals, which carry a program downloaded, for example, from a server on the Internet, are a kind of the medium which is readable by a computer. However, the electric signals are not included in the non-transitory and computer-readable storage medium.

The memory 12 stores a firmware 20 as a program executable by the controller 11. The following description in the present embodiment basically indicates processes performed by the controller 11, in accordance with instructions described in a program. That is, the processes such as "determination", "extraction", "selection", "calculation", "decision", "specification", "obtainment", "acceptance", and "control" in the following description represent the processes performed by the controller 11. Note that the "obtainment" is used as a concept which does not require a request. That is, a process in which the controller 11 receives data without requesting the data is also included in the concept of "the controller 11 obtains data". Further, the term "data" in the present specification is represented by a computer-readable bit string readable by the controller. Furthermore, a plurality of data items which have substantially the same meaning contents but have different formats are to be treated as being mutually the same. The same applies also to the term "information" in the present specification.

The firmware 20 also functions as a Web server 21 configured to display a predetermined Web page with respect to the PC 30. That is, the firmware 20 functions as an EWS (Embedded Web Server). The Web server 21 is capable of transmitting data for displaying the Web page to the PC 30 to thereby provide the Web page for a browser 41, of the PC 30, which will be described later. As will be described later, the MFP 10 is capable of accepting an operation via the Web page provided to the PC 30. That is, the Web server 21 is an example of the user interface.

Further, setting values 25 are stored in the memory 12. Although the term is referred to as the "setting value 25" for the sake of convenience, the setting value 25 contains a large number of setting values. The MFP 10 performs various operating processes based on the setting value 25. For example, the MFP 10 is capable of performing a communication using the network I/F 16 in accordance with a setting value related to the network included and included in the setting value 25. Further, a setting value of each of the USB I/F 18 and the USB I/F 19 is included in the setting value 25.

Next, the configuration of the PC 30 will be described. The PC 30 includes a network I/F 31, a memory 32, a controller 33, a display 34, a user I/F 35, and a USB I/F 36. The network I/F 31 is configured in the same manner as the network I/F 16 included in the MFP 30. The memory 32 is configured in the same manner as the memory 12 included in the MFP 30. The controller 33 has the same configuration as the controller 11 included in the MFP 30. The USB I/F 36 has the same configuration as the USB I/F 18 included in the MFP 30. Therefore, the description of the network I/F 31, the memory 32, the controller 33, and the USB I/F 36 will be omitted. The display 34 is constructed, for example, of an LCD. The user I/F 35 is constructed, for example, of a mouse, a keyboard, etc.

The memory 32 stores OS 40 and a browser 41. The browser 41 is capable of causing the display 34 to display an image in accordance with web page data transmitted from the MFP 10, under the control of the controller 33.

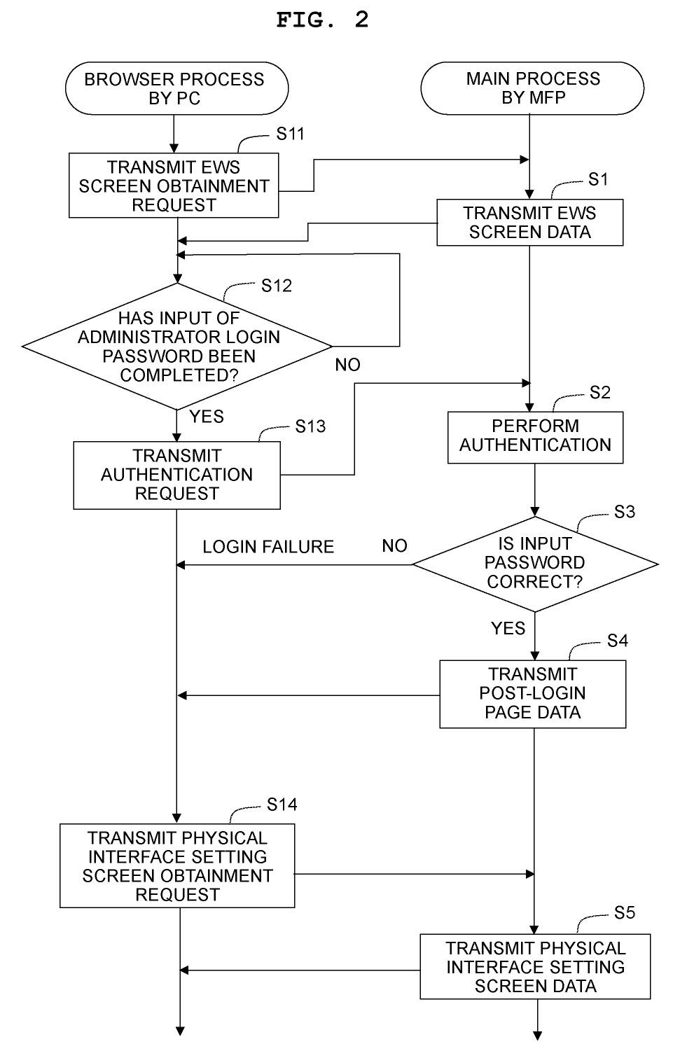

In the following, a control process performed by the image forming system 100 configured as described above will be described in detail, with reference to FIG. 2A to FIG. 9D.

FIG. 2 illustrates an example of a procedure in which the PC 30 obtains Physical Interface setting screen data from the MFP 10. Note that the term "Physical Interface" means a communication interface in the present embodiment. Thus, the FAX-I/F 15, the network I/F 16, the USB I/F 18 and the USB I/F 19, and the NFC I/F 22 are included in the Physical Interface. Hereafter, in the description of each of the processes, steps are each denoted as "step S".

A browser process illustrated in FIG. 2 indicates a process performed by the PC 30 starting from a state where the PC 30 is instructed to start the browser 41 and a browser screen is displayed on the display 34 of the PC 30. A logged-in user of the PC 30 who is, for example, the administrator of the MFP 10 inputs the URL of the EWS on the browser screen. The controlle 33 of the PC 30 transmits an EWS screen obtainment request to the MFP 10 (step S11). The EWS is implemented by a process performed by the controller 11 of the MFP 10. In this situation, a main process illustrated in FIG. 2 is a process performed by the controller 11 as the EWS. The main process starts in response to the power source of the MFP 10 being turned on.

In response to the controller 11 of the MFP 10 receiving the EWS screen acquisition request from the PC 30, the controller 11 transmits, to the PC 30, EWS screen data in accordance with the request from the PC 30 (step S1). The EWS screen data is a kind of the Web page data. In response to the controller 33 of the PC 30 receiving the EWS screen data from the MFP 10, the controller 33 causes the display 34 to display a browser screen based on the EWS screen data. The controller 33 of the PC 30 stands by until an administrator login password is input from a login password input field included in the EWS screen (step S12: NO). Then, in response to the administrator login password being input (step S12: YES), the controller 33 transmits an authentication request using the administrator login password to the MFP 10 (step S13).

Upon the controller 11 of the MFP 10 receiving the authentication request from the PC 30, the controller 11 performs the authentication (step S2), and determines whether the input administrator login password is correct (step S3). In a case where the controller 11 determines in step S3 that the input administrator login password is incorrect (step S3: NO), the controller 11 performs transmission of "login failure" to the PC 30. On the other hand, in a case where the controller 11 determines in step S3 that the input administrator login password is correct (step S3: YES), the controller 11 transmits post-login page data for the EWS screen to the PC 30 (step S4).

In response to the controller 33 of the PC 30 receiving the post-login page data from the MFP 10, the controller 33 displays a post-login page. The post-login page displays options corresponding to the Physical Interface setting screen. In response to the administrator operating an option among the options, the controller 33 of the PC 30 transmits a Physical Interface setting screen obtainment request to the MFP 10 (step S14).

In response to the controller 11 of the MFP 10 receiving the Physical Interface setting screen obtainment request from the PC 30, the controller 11 transmits, to the PC 30, Physical Interface setting screen data in accordance with the request from the PC 30 (step S5). In response to the controller 33 of the PC 30 receiving the Physical Interface setting screen data from the MFP 10, the controller 33 displays the Physical Interface setting screen.

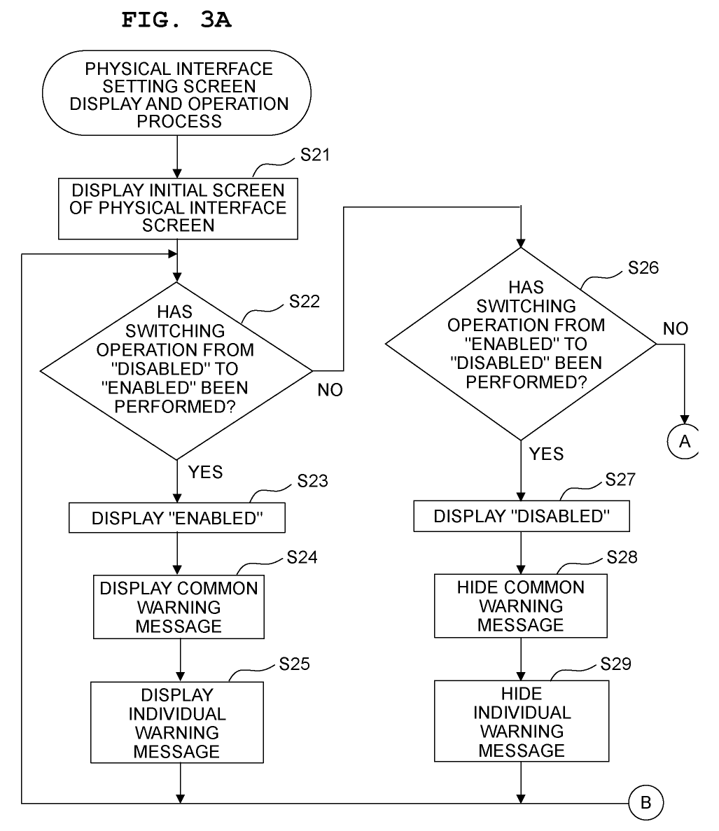

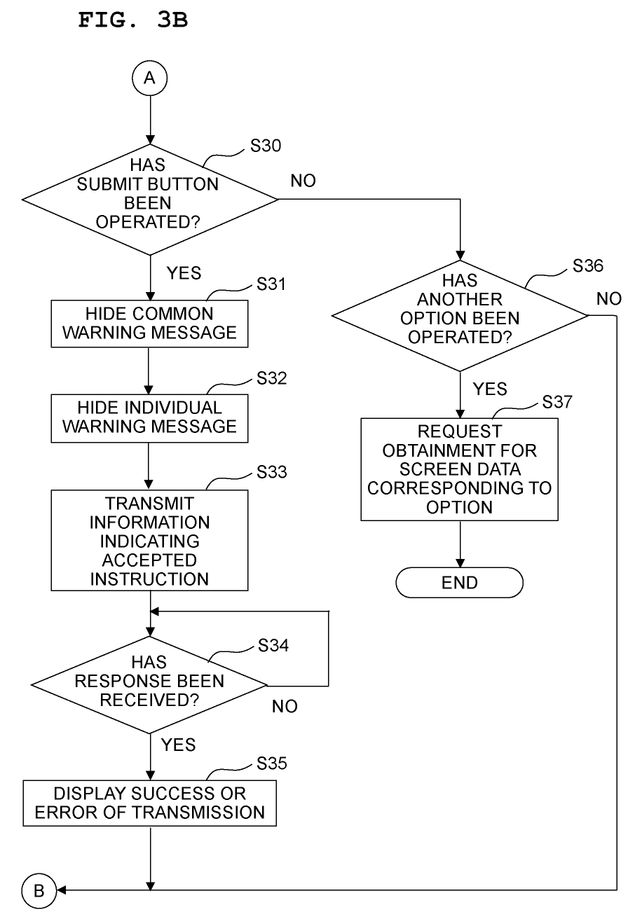

FIGS. 3A and 3B illustrate the procedure of a Physical Interface setting screen display and operation process. The Physical Interface setting screen display and operation process is performed by the controller 33 of the PC 30.

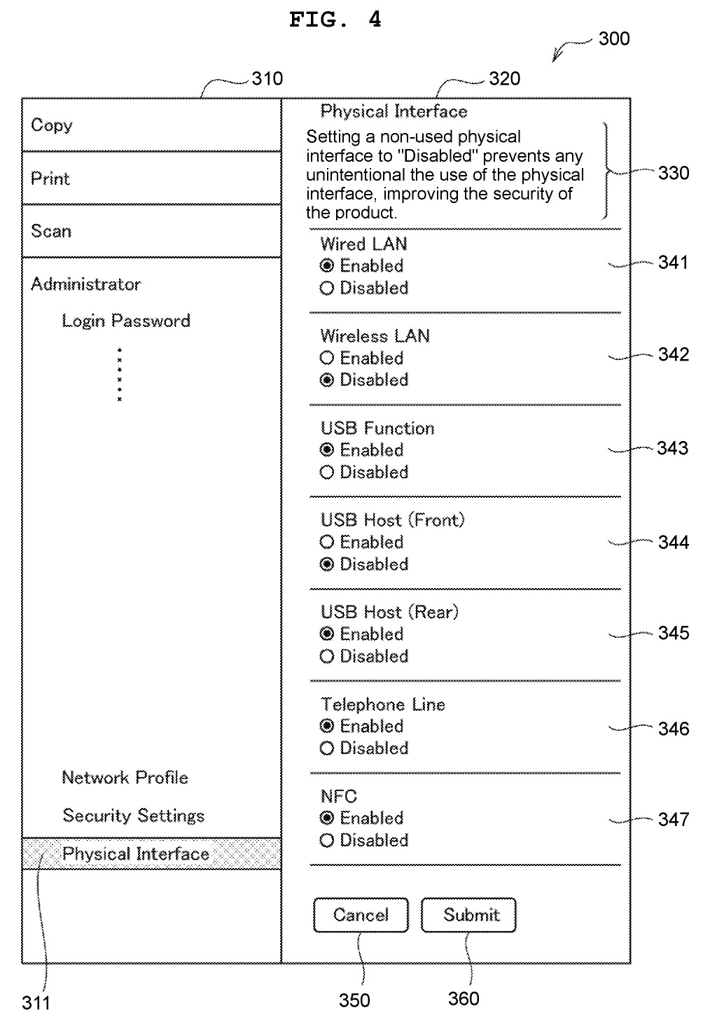

With reference to FIGS. 3A and 3B, the controller 33 firstly causes the display 34 to display the initial screen of the Physical Interface setting screen (step S21). The Physical Interface setting screen is a screen based on the received Physical Interface setting screen data. FIG. 4 illustrates an example of an initial screen 300 of the Physical Interface setting screen. As illustrated in FIG. 4, the initial screen 300 of the Physical Interface setting screen includes a menu 310 and a content display part 320. In FIG. 4, a subordinate option "Physical Interface" 311 of an option "Administrator" of the menu 310 is selected. Then, the content display part 320 displays items 341 to 347 via each of which an instruction to enable or disable a corresponding one of various Physical Interfaces included in the MFP 10.

An item "Wired LAN" 341 is an item which accepts an instruction to enable or disable a wired network I/F included in the network I/F 16. An item "Wireless LAN" 342 is an item which accepts an instruction to enable or disable a wireless network I/F included in the network I/F 16. An item "USB Function" 343 is an item which accepts an instruction to enable or disable the USB I/F 18. An item "USB Host (Front)" 344 is an item which accepts an instruction to enable or disable the Standard-A receptacle disposed in the front surface of the casing of the MFP 10. The Standard-A receptacle disposed in the front surface of the casing of the MFP 10 is included in the USB I/F 19. An item "USB Host (Rear)" 345 is an item which accepts an instruction to enable or disable the Standard-A receptacle disposed in the rear surface of the casing of the MFP 10. The Standard-A receptacle disposed in the rear surface of the casing of the MFP 10 is also included in the USB I/F 19. An item "Telephone Line" 346 is an item which accepts an instruction to enable or disable the FAX-I/F 15. An item "NFC" 347 is an item which accepts an instruction to enable or disable the NFC I/F 22. Enabling or disabling the interface may be paraphrased as enabling or disabling the function using a device connected to the interface.

In response to the administrator selecting, in the content display part 320, any one of radio buttons "Enabled" each included in corresponding one of the items 341 to 374, the administrator designates a certain interface, which is included in the wired network I/F included in the network I/F 16, the wireless network I/F included in the network I/F 16, the USB I/F 18, the Standard-A receptacles included in the USB I/F 19, the FAX-I/F 15 and NFC I/F and which corresponds to the operated radio button, to be set to enabled. On the other hand, in response to the administrator selecting any one of radio buttons "Disabled" each included in a corresponding one of the items 341 to 374, the administrator designates a certain interface which is included in the above-described interfaces and which corresponds to the operated radio button, to be set to disabled. Note that operating the radio button "Enabled" and the radio button "Disabled" toggles between "on" and "off" in an exclusive manner. That is, in response to the radio button "Enabled" being selected to be turned "on", the radio button "Disabled" is automatically turned "off". On the contrary, in response to the radio button "Disabled" is selected to be turned "on", the radio button "Enabled" is automatically turned "off".

The content display part 320 displays a disable recommendation message 330 indicating "Setting a non-used physical interface to "Disabled" prevents any unintentional use of the physical interface, improving the security of the product". The content display part 320 also displays a Cancel button 350 and a Submit button 360. In response to the Submit button 360 being operated, information indicating the instruction to enable or disable the physical interface, which has been accepted with respect to each of the items 341 to 374 is transmitted to the MFP 10. On the other hand, in response to the Cancel button 350 being operated, however, the information indicating the instruction to enable or disable the physical interface is not transmitted to the MFP 10.

Returning to FIG. 3A, the controller 33 next determines whether a switching operation for switching any one of the radio buttons each included in a corresponding one of the items 341 to 374 from being disabled to being enabled has been performed (step S22). For example, the item "USB Host (Front)" 344 illustrated in FIG. 4 is a state where the radio button "Disabled" is selected. In response to the administrator selecting the radio button "Enabled" in this state, the controller 33 determines "YES" in step S22, and the controller 33 displays "Enabled" (step S23). Specifically, the controller 11 turns on the radio button "Enabled" of the item "USB Host (Front)" 344. Further, the controller 33 displays a common warning message (step S24) and displays an individual warning message (step S25) in the item "USB Host (Front)" 344. Then, the controller 33 returns the process to step S22.

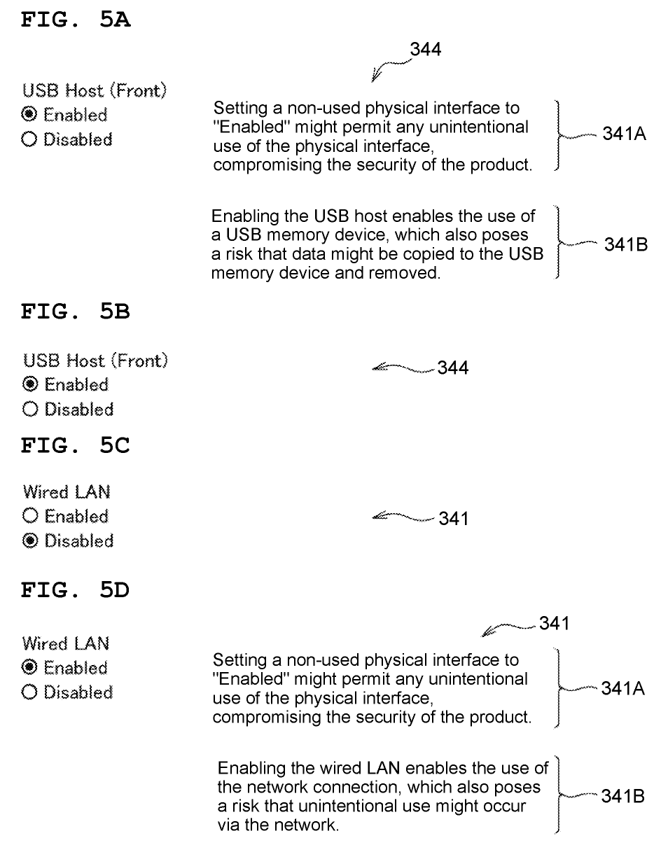

FIG. 5A illustrates a display state of the item "USB Host (Front)" 344 in a case where the process proceeds from step S23 to step S25. The display state of the item "USB Host (Front)" 344 illustrated in FIG. 5A is different from the display state of the item "USB Host (Front)" 344 illustrated in FIG. 4 in the following points. That is, the display state of the item "USB Host (Front)" 344 illustrated in FIG. 5A is different from the display state of the item "USB Host (Front)" 344 illustrated in FIG. 4 in that the radio button "Disabled" is turned off, and the radio button "Enabled" is turned on. Further, the display state of the item "USB Host (Front)" 344 illustrated in FIG. 5A is different from the display state illustrated in FIG. 4 in that a common warning message 344A and an individual warning message 344B are displayed. In the present embodiment, the common warning message 344A is a message having content indicating that "Setting a non-used physical interface to "Enabled" might permit any unintentional use of the physical interface, compromising the security of the product". In the present embodiment, the individual warning message 344B is a message having content indicating "Enabling the USB host enables the use of a USB memory device, which also poses a risk that data might be copied to the USB memory device and removed". Via the display of the individual warning message 344B in addition to the common warning message 344A, the administrator can be notified of a more specific risk which might be caused by enabling the USB I/F 19.

Returning to FIG. 3B, such a case is assumed where the administrator operates the Submit button 360 in a state where the radio button of the item "USB Host (Front)" 344 is turned on to "Enabled". In this assumed case, the controller 33 determines that the Submit button 360 has been operated (step S30: YES). The controller 33 proceeds the process from step S30 to step S31, and the controller 33 hides the common warning message. Further, the controller 33 hides the individual warning message (step S32).

FIG. 5B illustrates a display state of the item "USB Host (Front)" 344 in a case where the process proceeds from step S31 to step S32. The display state of the item "USB Host (Front)" 344 illustrated in FIG. 5B is different from the display state of the item "USB Host (Front)" 344 illustrated in FIG. 5A in the following points. That is, the display state of the item "USB Host (Front)" 344 illustrated in FIG. 5A is different from the display state of the item "USB Host (Front)" 344 illustrated in FIG. 5B in that both of the common warning message 344A and the individual warning message 344B are hidden. Note, however, that the display state of the item "USB Host (Front)" 344 illustrated in FIG. 5A is not different from the display state illustrated in FIG. 5A in that the radio button "Enabled" is turned on.

Returning to FIG. 3B again, the controller 33 subsequently transmits information indicating the accepted instruction to the MFP 10 (step S33). For example, information indicating that the radio button "Enabled" of the item "USB Host (Front)" 344 is instructed to be turned on, is transmitted from the PC 30 to the MFP 10. The MFP 10 updates the setting value 25 in accordance with the information received from the PC 30. For example, the MFP 10 updates the setting value 25 so as to indicate that the Standard-A receptacle disposed in the front surface of the casing of the MFP 10 is to be enabled.

Next, the controller 33 stands by until the controller 33 receives a response from the MFP 10 in response to the controller 33 transmitting the information in step S33 (step S34: NO). Then, the controller 33 receives the response from the MFP 10 (step S34: YES). In accordance with the response, the controller 33 causes the display 34 to display the success or error of the transmission in step S33 (step S35). Then, the controller 33 returns the process to step S22. The controller displaying the success in step S33 means that the MFP 10 has correctly received the information transmitted from the PC 30. Therefore, in a case where the controller 33 causes the display 34 to display the success, the controller 11 of the MFP correctly overwrites, in accordance with the information transmitted from the PC 30, the setting value included in the setting value 25 and corresponding to the information.

On the other hand, in a case where the controller 33 determines in step S22 that the switching operation for switching any one of the radio buttons each included in a corresponding one of the items 341 to 374 from being disabled to being enabled has not been performed (step S22: NO), the controller 33 determines whether the switching operation for switching any one of the radio buttons each included in a corresponding one of the items 341 to 374 from being enabled to being disabled has not been performed (step S26). For example, the item "Wired LAN" 341 illustrated in FIG. 4 is in a state where the radio button "Enabled" is selected. For example, in response to the administrator selecting the radio button "Disable" in this state, the controller 33 determines "YES" in step S26, and the controller 33 displays "Disabled" (step S27). Specifically, the controller 33 turns on the radio button "Disabled" of the item "Wired LAN " 341. Further, the controller 33 hides the common warning message (step S28) and hides the individual warning message (step S29) in the item "Wired LAN" 341. Then, the controller 33 returns the process to step S22.

FIG. 5C illustrates a display state of the item "Wired LAN" 341 in a case where the process proceeds from step S27 to step S29. The display state of the item "Wired LAN" 341 illustrated in FIG. 5C is different from the display state of the item "Wired LAN" 341 illustrated in FIG. 4 in the following points from the display state illustrated in FIG. 4. That is, the display state of the item "Wired LAN" 341 illustrated in FIG. 5C is different from the display state of the item "Wired LAN" 341 illustrated in FIG. 4 in that the radio button "Enabled" is turned off, and the radio button "Disabled" is turned on. In the initial screen 300 of the Physical Interface setting screen, the radio button "Enabled" of the item "Wired LAN" 341 is turned on. However, in a case where the initial screen 300 is displayed, the switching operation is not performed with respect to any of the radio buttons each included in a corresponding one of the items 341 to 347. Therefore, neither the common warning message nor the individual warning message is displayed. The common warning message and the individual warning message are not displayed from the beginning. Therefore, even in a case where the common warning message and the individual warning message are repeatedly hidden, the appearance that the common warning message and the individual warning message are hidden remains the same.

The administrator operates the radio button "Enabled" of the item "Wired LAN" 341, without operating the Submit button 360. The controller 33 proceeds the process from step S22 to step S23. Then, the controller 33 performs the processes of step S23 to step S25 described above. FIG. 5D illustrates a display state of the item "Wired LAN" 341 in a case where the process proceeds from step S23 to step S25. The display state of the item "Wired LAN" 341 illustrated in FIG. 5D is different from the display state of the item "Wired LAN" 341 illustrated in FIG. 5C in the following points. That is, the display state of the item "Wired LAN" 341 illustrated in FIG. 5D is different from the display state of the item "Wired LAN" 341 illustrated in FIG. 5C in that the radio button "Disabled" is turned off, and the radio button "Enabled" is turned on. Further, the display state of the item "Wired LAN" 341 illustrated in FIG. 5D is different from the display state of the item "Wired LAN" 341 illustrated in FIG. 5C in that the common warning message 341A and the individual warning message 341B are displayed. As described above, the common warning message 341A is the message having content indicating that "Setting a non-used physical interface to "Enabled" might permit any unintentional use of the physical interface, compromising the security of the product". In the present embodiment, the individual warning message 341B is a message having content indicating that "Enabling the wired LAN enables the use of the network connection, which also poses a risk that unintentional use might occur via the network". Via the display of the individual warning message 341B in addition to the common warning message 341A, the administrator can be notified of a more specific risk which might be caused by enabling the wired network I/F.

Further, the administrator operates the radio button "Disabled" of the item "Wired LAN" 341, without operating the Submit button 360. The controller 33 proceeds the process from step S26 to step S27. Then, the controller 33 performs the processes of step S27 to step S29 described above. FIG. 5C also illustrates a display state of the item "Wired LAN" 341 in a case where the controller 33 proceeds the process from step S27 to step S29. The display state of the item "Wired LAN" 341 illustrated in FIG. 5C is different from the display state of the item "Wired LAN" 341 illustrated in FIG. 5D in the following points. That is, the display state of the item "Wired LAN" 341 illustrated in FIG. 5C is different from the display state of the item "Wired LAN" 341 illustrated in FIG. 5D in that the radio button "Enabled" is turned off, and the radio button "Disabled" is turned on. Further, the display state of the item "Wired LAN" 341 illustrated in FIG. 5C is different from the display state of the item "Wired LAN" 341 illustrated in FIG. 5D in that both of the common warning message 344A and the individual warning message 344B are hidden. The controller 33 hides both of the common warning message 344A and the individual warning message 344B due to the following difference. That is, disabling the wired network I/F eliminates the risk of the security that the wired network I/F is compromised.

As illustrated in FIGS. 3A and 3B, in response to the controller 33 determining "NO" in any one of step S22, step S26, and step S30, the controller 33 determines whether another option, except for the option "Physical Interface" 311, has been operated in the menu 310 (step S36). In response to the controller 33 determines in step S36 that the another option has been operated (step S36: YES), the controller 33 transmits, to the MFP 10, an obtainment request for screen data corresponding to the selected option (step S37), in a similar manner to the process in step S14 illustrated in FIG. 2. The controller 33 terminates the Physical Interface setting screen display and operation process. On the other hand, in response to the controller 33 determines in step S36 that the another option has not been operated (step S36: NO), the controller 33 returns the process to step S22.

The specific content of each of the individual warning messages has been described regarding the item "Wired LAN" 341 and the item "USB Host (Front)" 344. The items other than the item "Wired LAN" 341 and the item "USB Host (Front)" 344 will be described below. Specifically, the item "Wireless LAN" 342, the item "USB Function" 343, the item "Telephone Line" 346, and the item "NFC" 347 will be described.

An individual warning message regarding the item "Wireless LAN" 342 is a message having content indicating that "Enabling the wireless LAN enables the use of the network connection, which also poses a risk that unintentional use might occur via the network".

An individual warning message regarding the item "USB Function" 343 is a message having content indicating that "Enabling the USB function enables the connection to the PC, which also poses a risk that unintentional use might occur via the PC".

An individual warning message regarding the item "Telephone Line" 346 is a message having content indicating that "Enabling the telephone line enables the use of the fax, which also poses a risk that the cost of unintentional communication might occur".

An individual warning message regarding the item "NFC" 347 is a message having content indicating that "Enabling NFC enables the use of card touch, which also poses a risk of unauthorized login when a card of any person other than the owner is touched during user authentication".

Note that the content of the message exemplified in each of the individual warning messages is merely exemplary in every sense, and does not limit the present disclosure to the exemplified messages.

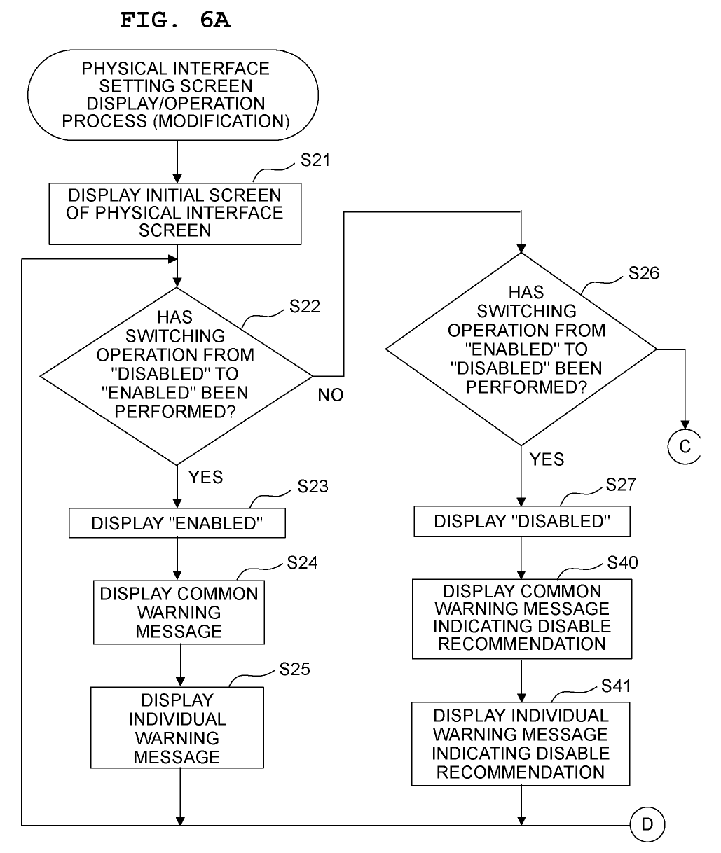

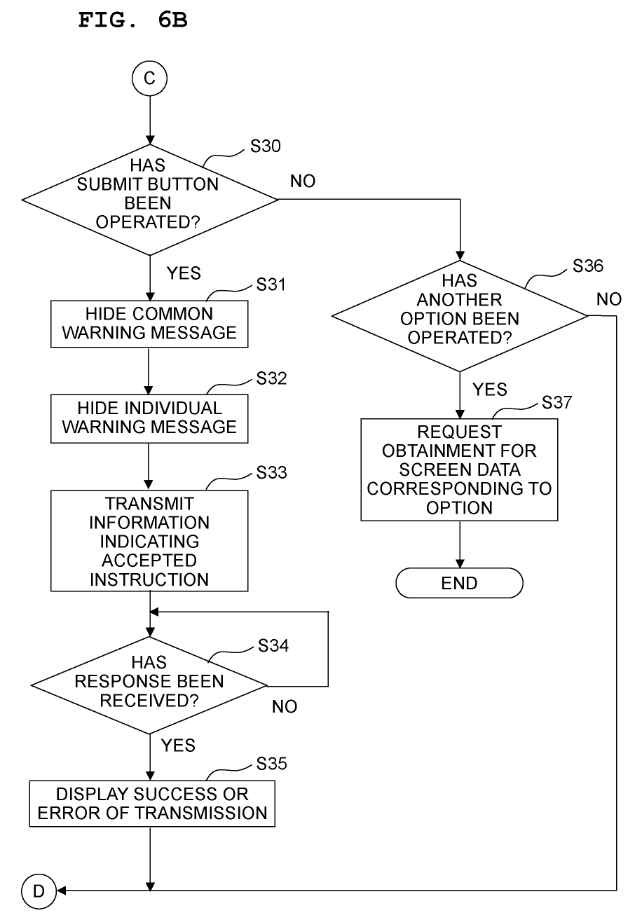

FIGS. 6A and 6B illustrate the procedure of a modification of the Physical Interface setting screen display and operation process. The Physical Interface setting screen display and operation process illustrated in FIGS. 6A and 6B is configured by partially changing the Physical Interface setting screen display and operation process illustrated in FIGS. 3A and 3B. Therefore, in FIGS. 6A and 6B, the processes, which are the same as the processes illustrated in FIGS. 3A and 3B, are designated by the same step numbers, and any description therefor will be appropriately omitted.

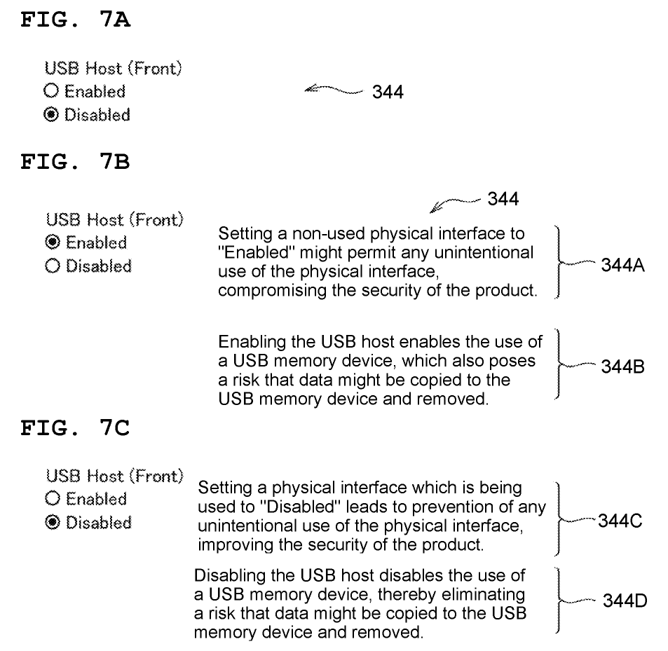

FIG. 7A illustrates a display state which is the same as the display state of the item "USB Host (Front)" 344 illustrated in FIG. 4. In the display state illustrated in FIG. 7A, the administrator operates the radio button "Enabled" of the item "USB Host (Front)" 344. In FIG. 6A, the controller 33 proceeds the process from step S22 to step S23. Then, the controller 33 performs the processes of step S23 to step S25 described above.

FIG. 7B illustrates a display state of the item "USB Host (Front)" 344 in a case where the process proceeds from step S23 to step S25. The display state of the item "USB Host (Front)" 344 illustrated in FIG. 7B is the same as the display state of the item "USB Host (Front)" 344 illustrated in FIG. 5A. In response to the administrator operating the radio button "Disabled" of the item "USB Host (Front)" 344 in this state, the controller 33 proceeds, in FIG. 6A, the process from step S26 to step S27. In step S27, the controller 33 displays "Disabled" in the same manner as step S27 illustrated in FIG. 3A. Then, the controller 33 displays a common warning message indicating the disable recommendation in the item "Wired LAN" 341 (step S40), and the controller displays an individual warning message indicating the disable recommendation (step S41). The controller 33 returns the process to step S22.

FIG. 7C illustrates a display state of the item "USB Host (Front)" 344 in a case where the process proceeds from step S27 to step S41. The display state of the item "USB Host (Front)" 344 illustrated in FIG. 7C is different from the display state of the item "USB Host (Front)" 344 illustrated in FIG. 7B in the following points. That is, the display state of the item "USB Host (Front)" 344 illustrated in FIG. 7C is different from the display state of the item "USB Host (Front)" 344 illustrated in FIG. 7B in that the radio button "Enabled" is turned off, and the radio button "Disabled" is turned on. Further, the display state of the item "USB Host (Front)" 344 illustrated in FIG. 7C is different from the display state of the item "USB Host (Front)" 344 illustrated in FIG. 7B in that the common warning message 344C indicating the disable recommendation and the individual warning message 344D indicating the disable recommendation are displayed. In the present embodiment, the common warning message 344C indicating the disable recommendation is a message having content indicating that "Setting a physical interface which is being used to "Disabled" leads to prevention of any unintentional use of the physical interface, improving the security of the product". The individual warning message 344D indicating the disable recommendation is a message having content indicating that "Disabling the USB host disables the use of a USB memory device, thereby eliminating a risk that data might be copied to the USB memory device and removed". The following effect is obtained by displaying the individual warning message 344D indicating the disable recommendation, in addition to the common warning message 344C indicating the disable recommendation. That is, the controller 33 is capable of informing the administrator that the specific risk can be avoided by disabling the Standard-A receptacle disposed in the front surface of the casing of the MFP 10.

The specific content of each of the individual warning messages, which indicate the disable recommendation and which are other than the item "USB Host (Front)" 344, will be described in the following.

An individual warning message indicating the disable recommendation regarding the item "Wired LAN" 341 is a message having content indicating that "Disabling the wired LAN disables the use of the network connection, thereby eliminating a risk that unintentional use might occur via the network".

An individual warning message indicating the disable recommendation regarding the item "Wireless LAN" 342 is a message having content indicating that "Disabling the wireless LAN disables the use of the network connection, thereby eliminating a risk that unintentional use might occur via the network".

An individual warning message indicating the disable recommendation regarding the item "USB Function" 343 is a message having content indicating that "Disabling the USB function disables the connection to the PC, thereby eliminating a risk that unintentional use might occur via the PC".

An individual warning message indicating the disable recommendation regarding the item "Telephone Line" 346 is a message having content indicating that "Disabling the telephone line disables the use of the fax, thereby eliminating a risk that the cost of unintentional communication might occur".

An individual warning message indicating the disable recommendation regarding the item "NFC" 347 is a message having content indicating that "Disabling NFC disables the use of card touch, thereby eliminating a risk of unauthorized login when a card of any person other than the owner is touched during user authentication".

Note that the message content exemplified in each of the individual warning messages indicating the disable recommendation is merely exemplary in every sense, and does not limit the present disclosure to the exemplified messages.

Note that the controller 11 of the MFP 10 may generate all the EWS screen data items, and the controller 11 may transmit the data items to the PC 30. Further, the PC 30 may previously store the core part of the EWS screen data. The MFP 10 may previously transmit the core part of the EWS screen data to the PC 30, and the PC 30 may store the core part. In an example in which the PC 30 previously stores the core part of the EWS screen data, the MFP 10 may transmit a part of the EWS screen data to the PC 30. For example, the MFP 10 may transmit, to the PC 30, data indicating that which one of the two radio buttons included in each of the items 341 to 374 is to be turned on. The screen data of the Physical Interface setting screen is an example of the EWS screen data. The PC 30 may display the EWS screen in accordance with both of the previously stored EWS screen data and the EWS screen data received from the MFP 10. The EWS screen data may be data in the HTML format, data in the CSS format, data in the JavaScript (a registered trademark of Oracle Corporation) format, or data in any other format.

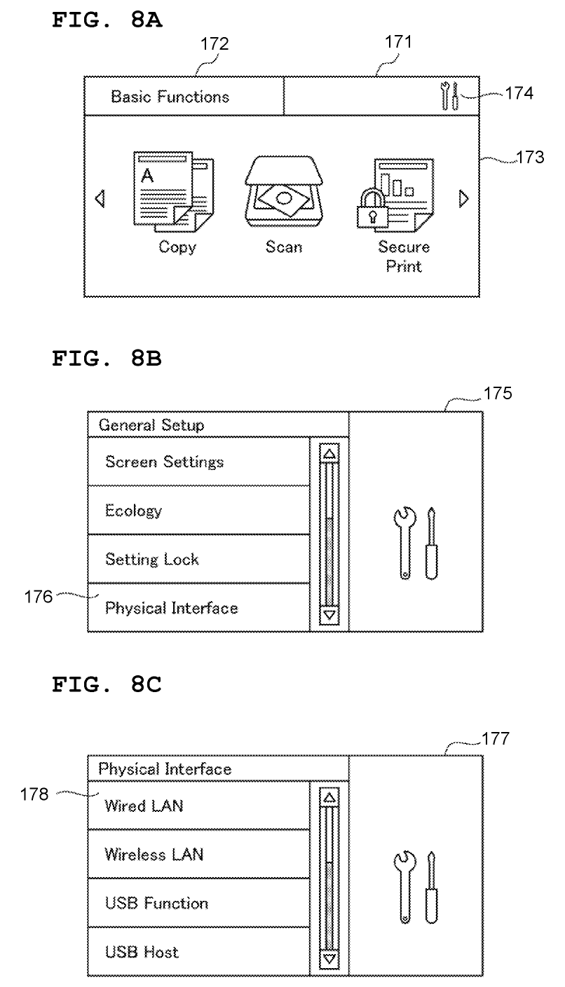

Next, a process for changing the setting of Physical Interface by operating the user I/F 17 of the MFP 10 will be described with reference to FIGS. 8 and 9.

FIG. 8A illustrates an example of a home screen 171 displayed on the touch panel 170. The home screen 171 is composed of a display region 172 which displays the internal state of the MFP 10, and a function selection region 173. The function selection region 173 is a region via which a function of the MFP 10 is selected. The copying function, the scanning function, and the secure printing function are examples of the function of the MFP 10. Further, a setting icon 174 is also displayed on the home screen 171. In response to the setting icon 174 being operated, the controller 11 of the MFP 10 causes the touch panel 170 to display a setting screen 175 illustrated in FIG. 8B.

An option "Physical Interface" 176 is displayed on the setting screen 175. In response to the option "Physical Interface" 176 being operated, the controller 11 causes the touch panel 170 to display a Physical Interface setting screen 177 illustrated in FIG. 8C. Options, each of which corresponds to a corresponding one of various Physical Interfaces included in the MFP 10, are displayed on the Physical Interface setting screen 177. In response to the option "Wired LAN" 178 being selected from the options, the controller 11 causes the touch panel 170 to display a Wired LAN setting screen 179 illustrated in FIG. 9A.

An option "Enabled" 180 and an option "Disabled" 181 are displayed on the Wired LAN setting screen 179. Further, the option "Disabled" 181 is displayed in a display mode indicating a selected state. In other words, the wired network I/F is enabled. In response to the option "Enabled" 180 being operated on the Wired LAN setting screen 179, the controller 11 causes the touch panel 170 to display a warning screen 182 illustrated in FIG. 9B.

A common warning message 183 is displayed on the warning screen 182. The common warning message 183 is a message same as the common warning message 344A displayed in the item "USB Hose (Front)" 344 illustrated in FIG. 5A. Further, an OK button 184 and a cancel button 185 are displayed on the warning screen 182. In response to the OK button 184 being operated, the controller 11 updates the setting value 25. Specifically, the controller 11 overwrites the setting value 25 to be a setting value indicating "Enabled" instructed by the option "Enabled" 180. Then, the controller 11 causes the touch panel 170 to display a Wired LAN setting screen 186 illustrated in FIG. 9D.

On the Wired LAN setting screen 186, the option "Enabled" 180 is displayed in a display mode indicating the selected state. Then, in response to the home key 272 of the key input part 270 being pressed, the controller 11 causes the touch panel 170 to display the home screen 171 illustrated in FIG. 8A.

FIG. 9C illustrates a modification 182A of the warning screen 182. In the modification 182A, an individual warning message 187 is displayed in addition to the common warning message 183. The individual warning message 187 is a message which is the same as the individual warning message 344B displayed in the item "USB Host (Front)" 344 illustrated in FIG. 5A. According to the modification 182A, a user of the MFP 10 can be notified of a specific risk which might be caused by enabling the wired network I/F.

As described above, the MFP 10 of the present embodiment includes the plurality of Physical Interfaces, the user I/F 17, and the controller 11. Each of the plurality of Physical Interfaces is configured to be enabled or disabled. The MFP 10 is capable of performing communication by using a communication interface which is included in the plurality of Physical Interfaces and which is set to enabled. Further, the controller 11 is capable of accepting, via the user I/F 17, the operation for instructing the controller 11 to designate a certain communication interface, which is included in the plurality of communication interfaces and which has been set to disabled, and to set the certain communication interface to enabled. The MFP 10 is capable of causing the user I/F 17 to display the common warning messages 341A, 344A, the common warning message 183, and the individual warning messages 341B, 344B, 187 each warning that the security might be compromised.

The MFP 10 according to the present embodiment is capable of issuing the warning in a case where the instruction to change the setting value might compromise the security.

In the present embodiment, the examples in each of which both of the common warning message and the individual warning message are displayed. However, only the common warning message may be displayed. Alternatively, only the individual warning message may be displayed.

In the present embodiment, the message is displayed on the content display part 320 in accordance with the operation with respect to the content display part 320 of the Physical Interface setting screen illustrated in FIG. 4. However, as illustrated in FIGS. 9B and 9C, the message may be displayed on the screen other than the Physical Interface setting screen.

In the present embodiment, in response to the option "Enabled" 180 being operated on the Wired LAN setting screen 179 illustrated in FIG. 9A, the warning screen 182 illustrated in FIG. 9B is displayed. In other words, the warning screen 182 is displayed on the screen distinct from the Wired LAN setting screen 179. However, the message displayed on the warning screen 182 may be displayed in the Wired LAN setting screen 179.

In the present embodiment, the example in which only the common warning message 183 is displayed on the warning screen 182 illustrated in FIG. 9B has been described. Further, the example in which the common warning message 183 and the individual warning message 187 are displayed in the modification 182A illustrated in FIG. 9C has been described. Alternatively, a screen, which includes a message corresponding to the common warning message 344C indicating the disable recommendation, may also be displayed. Further, a screen, which includes a message corresponding to the individual warning message 344D indicating the disable recommendation, may also be displayed.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the embodiment described above, the MFP 10 receives the request from the browser 41 via the network I/F 16, and the MFP 10 provides the Web page data to the browser 41. The present disclosure is not limited to the above-described configuration regarding the network I/F 16, and the following configuration may also be adopted. That is, for example, such a configuration may be adopted wherein the MFP 10 receives a request for HTTPS from the browser 41 via a USB I/F, and where the MFP 10 responds to the browser 41 with Web page data, via the USB I/F. The USB I/F, via which the MFP 10 receives the request from the browser 41, is an example of the user I/F 17. Further, the USB I/F, via which the MFP which provides the Web page data, is also an example of the user I/F 17.

In the embodiment described above, although the MFP 10 has been described as an example of the printing apparatus, the printing apparatus is not limited to the MFP 10, and the printing apparatus may be a single-function printer.

In the present embodiment, the key input part, which is constructed of the three keys 271 to 273 and which is configured to switch each of the three keys between the lit state and the unlit state, is adopted as the key input part 270. However, the present disclosure is not limited to the above-described configuration. Three buttons corresponding to the three keys 271 to 273, respectively, may be displayed on the touch panel 170. The control for displaying or hiding each of the buttons may be performed, rather than the control for switching each of the buttons between the lit state and the unlit state.

What is claimed is:

1. An image forming apparatus comprising:
a plurality of communication interfaces;
a user interface; and
a controller,
wherein each of the plurality of communication interfaces is configured to be set to enabled or disabled,
the image forming apparatus is capable of communicating via a communication interface included in the plurality of communication interfaces and set to enabled, and
in response to the controller accepting a designating and enabling operation via the user interface, the controller is configured to cause the user interface to display a message warning a security compromise, the designating and enabling operation being an operation for instructing the controller to designate a communication interface in the plurality of communication interfaces being set to disabled, and to set the communication interface to enabled.

2. The image forming apparatus according to claim 1, wherein
the controller is configured to accept, via the user interface or the plurality of communication interfaces, an administrator operation performed by an administrator and a non-administrator operation performed by a person other than the administrator,
in response to the controller accepting the administrator operation for instructing the controller to designate a communication interface in the plurality of communication interfaces being set to enabled, and to set the communication interface to disabled, the controller is configured to set the communication interface to disabled, and
in response to the controller accepting, via the user interface, the non-administrator operation for instructing the controller to set the communication interface, which has been set to disabled in accordance with the administrator operation, to enabled, the controller is configured to cause the user interface to display the message warning the security compromise.

3. The image forming apparatus according to claim 1, wherein
in response to the controller accepting, via the user interface, an operation for designating a communication interface in the plurality of communication interfaces being set to disabled, and for setting the communication interface to enabled, the controller is configured to cause the user interface to display the message warning the security compromise, and
in response to the controller accepting, via the user interface, an operation for designating a communication interface in the plurality of communication interfaces being set to enabled, and for setting the communication interface to disabled, the controller is configured to cause the user interface to display a message indicating improvement of the security.

4. The image forming apparatus according to claim 3, wherein
the controller is configured to accept, via the user interface or the plurality of communication interfaces, an administrator operation performed by an administrator and a non-administrator operation performed by a person other than the administrator,
in response to the controller accepting, via the user interface, an instruction by the non-administrator operation, to designate a communication interface in the plurality of communication interfaces being set to disabled in accordance with the administrator operation, and to set the communication interface to enabled, the controller is configured to cause the user interface to display the message warning the security compromise, and
in response to the controller accepting, via the user interface, an instruction by the non-administrator operation, to designate a communication interface in the plurality of communication interfaces being set to enabled, and to set the communication interface to disabled, the communication interface being included in the plurality of communication interfaces and having been set to enabled, the controller is configured to cause the user interface to display the message indicating the improvement of the security.

5. The image forming apparatus according to claim 1, wherein
the controller is configured to cause the user interface to display a message indicating a warning content in accordance with each of the communication interfaces in the plurality of communication interfaces for which the controller having accepted the designating and enabling operation.

6. The image forming apparatus according to claim 5, wherein
the message indicating the warning content in accordance with each of the communication interfaces includes:
words of a common content irrelevant to a type of each of the communication interfaces; and
words of a content in accordance with the type of each of the communication interfaces.

7. The image forming apparatus according to claim 5, wherein
in a case that a communication interface in the communication interfaces which is a target of the designating and enabling operation is a network interface, the controller is configured to cause the user interface to display a message containing a warning content indicating a risk of unintentional use of the image forming apparatus via a network.

8. The image forming apparatus according to claim 5, wherein
in a case that a communication interface in the communication interfaces which is a target of the designating and enabling operation is a USB interface to which an external device is connectable, the controller is configured to cause the user interface to display a message containing a warning content indicating a risk of unintentional use of the image forming apparatus in response to the external device being connected to the USB interface.

9. The image forming apparatus according to claim 5, wherein
in a case that a communication interface in the communication interfaces which is a target of the designating and enabling operation is a USB interface to which a USB memory device is attachable, the controller is configured to cause the user interface to display a message containing a warning content indicating a risk caused in response to the USB memory device being attached to the USB interface.

10. The image forming apparatus according to claim 5, wherein
in a case that a communication interface in the communication interfaces which is a target of the designating and enabling operation is a telephone line, the controller is configured to cause the user interface to display a message containing a warning content indicating a risk of unintentional communication being performed via the telephone line.

11. The image forming apparatus according to claim 5, wherein
in a case that a communication interface in the communication interfaces which is a target of the designating and enabling operation is a Near Field Communication interface, the controller is configured to cause the user interface to display a message containing a warning content indicating a risk of unintentional communication being performed via the Near Field Communication interface.

12. The image forming apparatus according to claim 1, wherein
in response to the controller accepting the designating and enabling operation via a setting screen displayed on the user interface, the controller is configured to cause the user interface to display the message warning the security compromise on the setting screen, and
in response to the controller accepting, via the setting screen, an operation for confirming a setting by which the communication interface set to disabled is designated and is set to enabled in a state where the message warning the security compromise is displayed on the setting screen, the controller is configured to set the communication interface which is a target of the operation for confirming the setting, to enabled.

13. The image forming apparatus according to claim 12, wherein
in a state where the message warning the security compromise is displayed on the setting screen, the message being with respect to the communication interface which has been instructed to be designated and set to enabled by the operation via the setting screen displayed on the user interface,
in response to the controller accepting, via the setting screen, the operation for confirming the setting, the controller is configured to set the communication interface, which is the target of the operation for confirming the setting, to enabled, and
in response to the controller accepting, via the setting screen, an operation for instructing the controller to set the communication interface to disabled, the controller is configured to cause the user interface to end display of the message warning the security compromise with respect to the communication interface and being displayed on the setting screen.

14. The image forming apparatus according to claim 12, wherein
in a state where the message warning the security compromise is displayed on the setting screen, the message being with respect to the communication interface which has been instructed to be designated and set to enabled by the operation via the setting screen displayed on the user interface,
in response to the controller accepting, via the setting screen, an operation for instructing the controller to set the communication interface to disabled, the controller is configured to cause the user interface to display a message indicating improvement of the security on the setting screen.

15. The image forming apparatus according to claim 1, wherein
in response to the controller accepting the designating and enabling operation via a setting screen displayed on the user interface, the controller is configured to cause the user interface to end display of the setting screen, and to cause the user interface to display the message warning the security compromise, with respect to the communication interface which is a target of the designating and enabling operation, and
in response to the controller accepting, via the user interface, an operation of confirming a setting by which the communication interface set to disabled is designated and is set to enabled in a state where the message warning the security compromise is displayed on the user interface, the controller is configured to set the communication interface, which is a target of the operation for confirming the setting, to enabled.

16. The image forming apparatus according to claim 15, wherein
in a state where the setting screen is not displayed with respect to the communication interface which has been designated by the operation via the setting screen displayed on the user interface and which is a target of the designating and enabling operation, and where the message indicating the security compromise is displayed on the user interface,
in response to the controller accepting, via the user interface, the operation for instructing the controller to confirm the setting, the controller is configured to set the communication interface, which is the target of the operation for confirming the setting, to enabled, and
in response to the controller accepting, via the user interface, a disabling operation for instructing the controller to set the communication interface which is a target of the designating and enabling operation, to disabled, the controller is configured to cause the user interface to end display of the message warning the security compromise which is displayed on the user interface with respect to the communication interface, and to cause the user interface to display the setting screen.
